(19) United States
(12) Patent Application Publication
(10) Pub. No.: US 2003/0050804 A1
(43) Pub. Date: Mar. 13, 2003

(54) Contract compliance monitoring system

(76) Inventor: Michael C. Hendershot, Evanston, IL (US)

Correspondence Address: Chart-Tech, Inc., Suite 220, 820 Davis Street, Evanston, IL, 60201, US

(21) Appl. No.: 10/238,507

(22) Filed: Sep. 9, 2002

Related U.S. Application Data
(60) Provisional application No. 60/318,020, filed on Sep. 7, 2001.

(51) Int. Cl. G06F 17/60

(52) U.S. Cl. 705/4

(57) ABSTRACT

This invention relates to a contract compliance monitoring system for comprehensive review of insurance claims and calculation of baselines for insurance claim reimbursement comprising a) import services, b) calculation services, c) reporting and report management services, d) analysis services, e) data manipulation services, f) external interface services, g) contract and confirmation document management services, h) security processing and confirmation. This invention further relates to a contract compliance monitoring system for comprehensive review of medical insurance claims and calculation of baselines for medical insurance claim reimbursement. This invention also relates to a contract compliance electronic monitoring system for compliance with contract terms for insurance claim baseline reimbursement. The method uses an external data processor and a web-based simple object access protocol and related subroutines for requesting the user's contract information, requesting and reviewing all parameters including the required data, calculations, interface, security level, confirmation, analysis of compliance and contract terms, and generating reports required by the user and providing the said services.

This application claims the filing date of Provisional Patent Application No. 60/318,020 filed Sep. 7, 2001.

### FIELD OF THE INVENTION

The present invention relates to a contract compliance monitoring system for comprehensive review of insurance claims and calculation of baselines for insurance claim reimbursement by insurance companies. The present invention further relates to a contract compliance monitoring system for comprehensive review of medical insurance claims and calculation of baselines for medical insurance claim reimbursement by insurance companies. The present invention further relates to a method of providing a contract compliance monitoring system for compliance of contract terms for insurance claim baseline reimbursement for users comprising the steps of a) requesting the user's desired contract information; b) requesting and reviewing the parameters including the required data, calculations, interface, security level, confirmations, analysis of the compliance and contract terms, and c) generating the reports requested by the user.

### BACKGROUND OF THE INVENTION

The contract compliance monitoring system (“CCMS”) was originally designed as a secure and scalable contract compliance audit utility geared towards a comprehensive review of medical claims payment accuracy. Over time, CCMS evolved from a contract compliance database utility into a very secure, highly reliable full service web-based application framework geared towards absolute accuracy (≅99%), high scalability/availability and unlimited potential for customization. Besides providing a comprehensive contract compliance monitoring utility, CCMS is designed to function as a very sophisticated calculation engine, which allows establishing of a baseline for reimbursement through a net payment scenario. CCMS utilizes sub-routines for documenting and retaining required calculations for classification and analysis as well as an extensible web reporting utility capable of retrieving any data in many different formats from the database to the browser or other database/system. CCMS is on a Microsoft® platform using XML/XSLT, Soap, visual basic and ASP. CCMS also uses encryption technologies such as SSL and industry firewall solutions for maximum in security and data privacy. XML, extensible markup language, is a standard used in transmission of data as well as description of the data that is being transmitted on the web. XSLT is a language used in transformation of XML Documents into other documents such as XML or HTML. Soap, simple object access protocol, is a lightweight scalable protocol used for communication in a decentralized distributed environment based on XML & HTTP standards. SSL is an encryption protocol used for encryption of data while it is in transit on the Internet.

### SUMMARY OF THE INVENTION

This invention relates to a contract compliance monitoring system (“CCMS”) for comprehensive review of insurance claims and calculation of baselines for insurance claim reimbursement comprising a) import services, b) calculation services, c) reporting and report management services, d) analysis services, e) data manipulation services, f) external interface services, g) contract and confirmation document management services, h) security processing and confirmation. This invention further relates to a contract compliance monitoring system for comprehensive review of medical insurance claims and calculation of baselines for medical insurance claim reimbursement. This invention relates to a contract compliance electronic monitoring system for compliance of contract terms for insurance claim baseline reimbursement. The method uses an external data processor and a web-based simple object access protocol and related sub-routines for requesting the user's contract information as to terms and claim baseline reimbursement, requesting and reviewing all parameters including the required data, calculations, interface, security level, confirmation, analysis of the compliance and contract terms, generating the required reports, and providing the said services.

### BRIEF DESCRIPTION OF THE DRAWINGS

FIG. 1 illustrates the flow of report and calculated data to the contract compliance monitoring system (CCMS) data base.

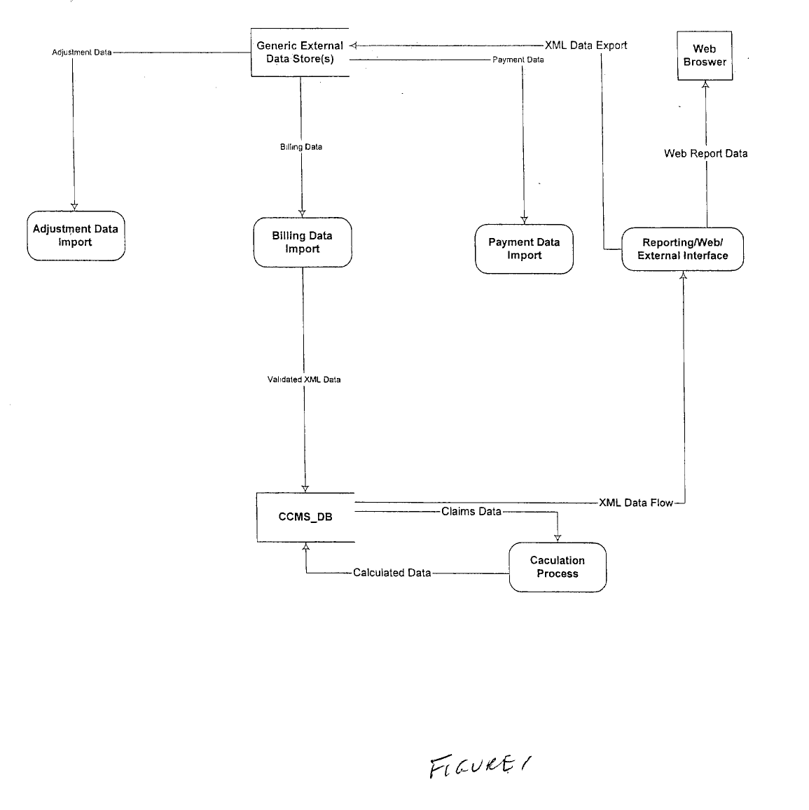

FIG. 2 illustrates the flow of external data using an external data processor from data sources in an import system to integrate the data through a conversion filter, the billing data importer, into a standard format to the CCMS system data base.

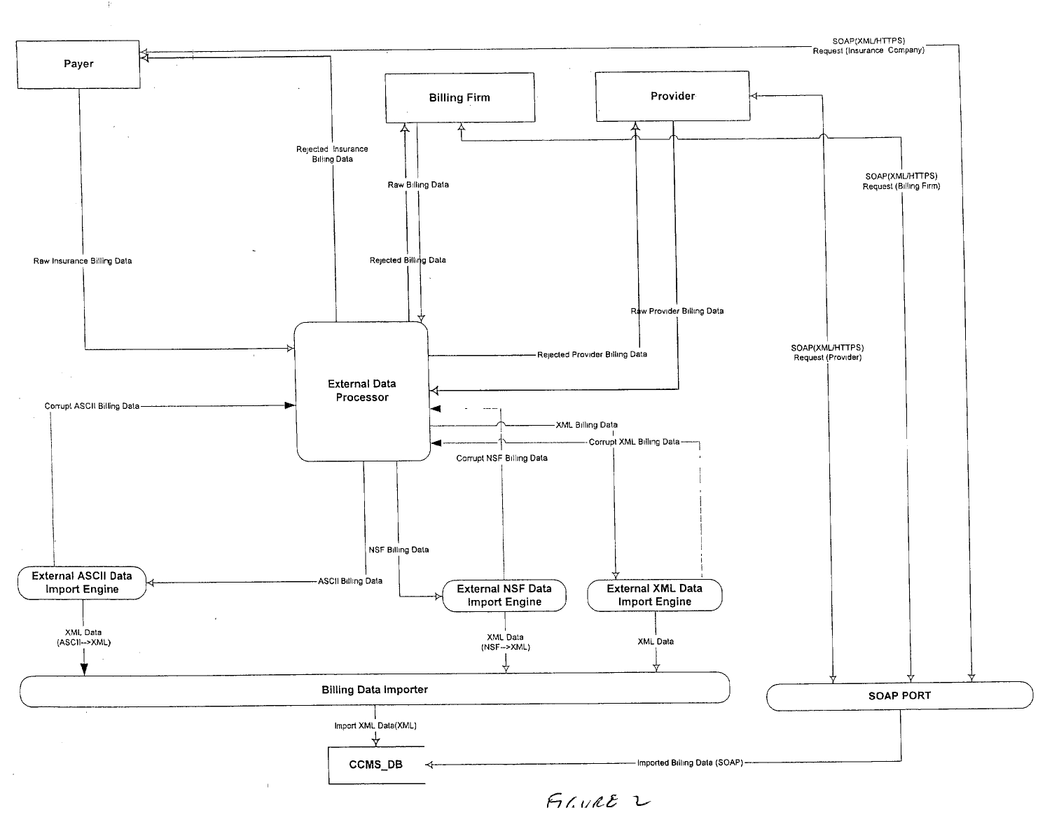

FIG. 3 illustrates the flow from data sources to the CCMS data base from the billing firm and payer, using an external data processor.

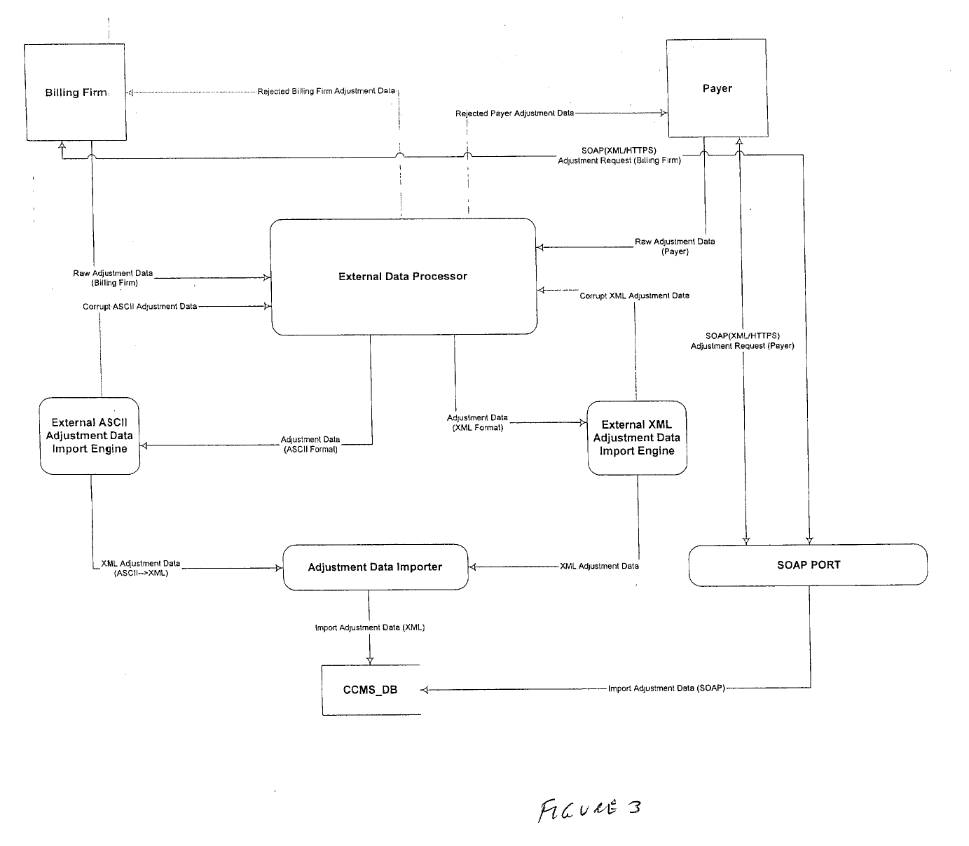

FIG. 4 illustrates the flow of data to the CCMS data base from the payer through an external data processor to process corrupt payment data.

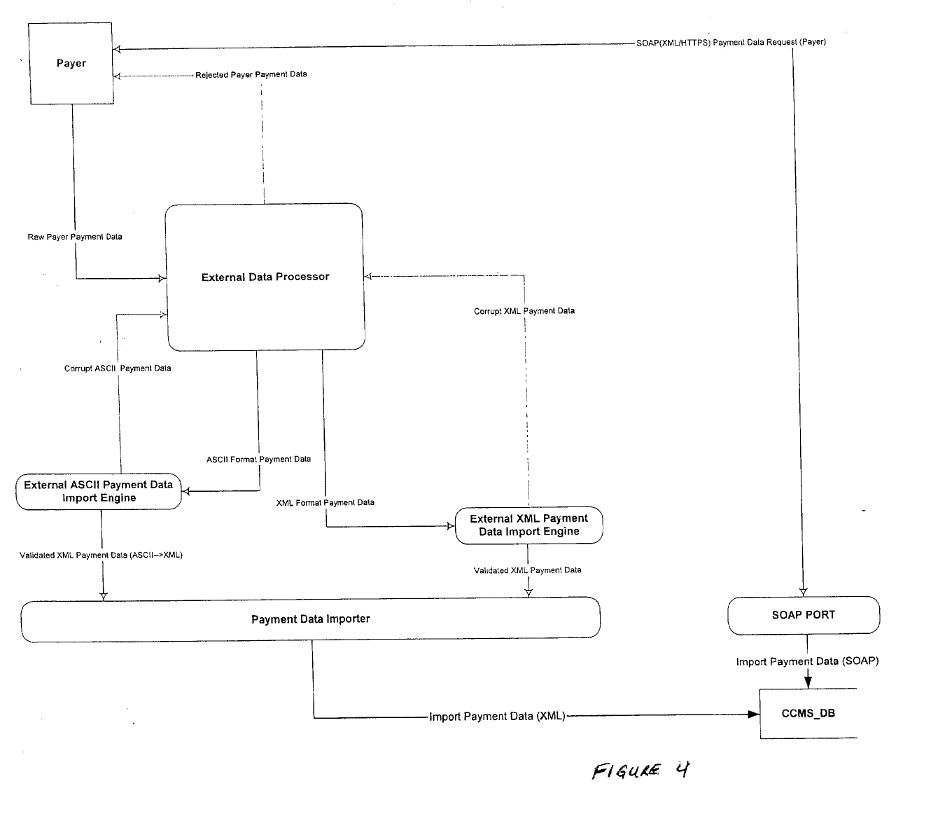

FIG. 5 illustrates the flow of data to the CCMS data base wherein the CCMS data base processes the claims data per specific contract business rules, calculates specific claims data, adjusts the claims data and payment data and provides the calculated results and the process trail.

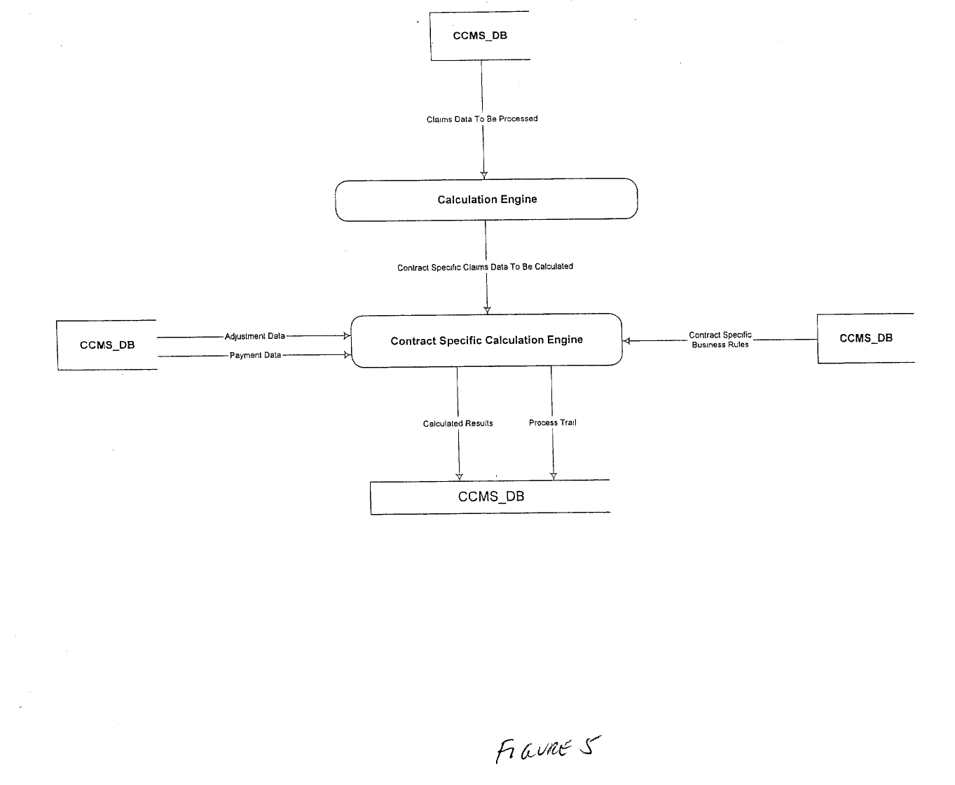

FIG. 6 illustrates the HTML web query interface which allows the user to view any report in the system that was deployed.

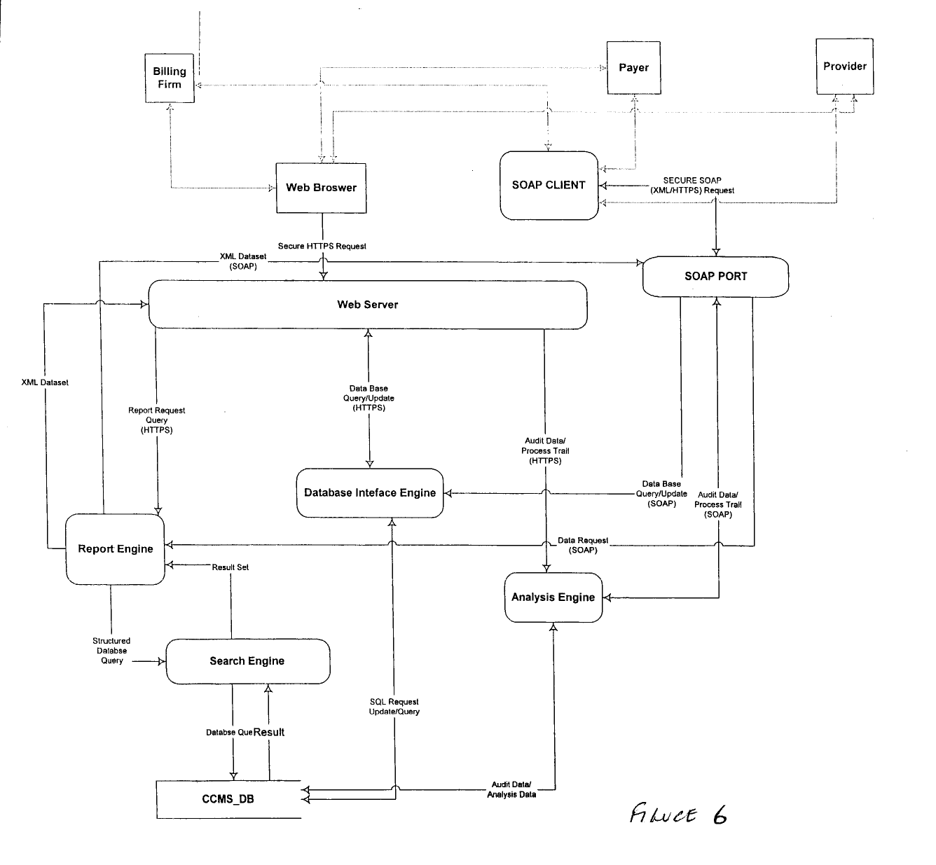

### DETAILS OF THE INVENTION

This invention relates to a contract compliance monitoring system (“CCMS”) for comprehensive review of insurance claims and calculation of baselines for insurance claim reimbursement comprising a) import services, b) calculation services, c) reporting and report management services, d) analysis services, e) data manipulation services, f) external interface services, g) contract and confirmation document management services, h) security processing and confirmation. This invention further relates to a contract compliance monitoring system for comprehensive review of medical insurance claims and calculation of baselines for medical insurance claim reimbursement. This invention relates to a contract compliance electronic monitoring system for compliance of contract terms for insurance claim baseline reimbursement. The method uses an external data processor and a web-based simple object access protocol and related sub-routines for requesting the user's contract information as to terms and claim baseline reimbursement, requesting and reviewing all parameters including the required data, calculations, interface, security level, confirmation, analysis of the compliance and contract terms, generating the required reports, and providing the said services.

CCMS consists of the following components:

Import Services

Calculation Services

Reporting/Report Management Services

Security Management Services

Analysis Services

Data Manipulation Services (Part of Claims Processing)

External Interface Services

Contract/Confirmation Document Management Services

I. Import Services

Early on and incorporated into this process is the recognition, that in a managed care environment the sources of data and data formats were frequently different. Inconsistent data formats and frequent data corruptions cost time and money. In response to these problems, an import services module (“ISM”) has been created, which facilitates, a seamless integration of two or more systems by leveraging of XML technologies. Import services is a flexible distributed system designed to handle incoming data from an unlimited number of data sources. The import process has the ability to accept three basic formats:

1) ASCII Format

a. Comma Delimited

b. Tab Delimited

2) NSF File Format

3) XML File Format

If the file is received in a format other than XML, the file is passed through a conversion filter, which converts the data into a standard XML format. The XML data is then validated against standard schemas developed by a commercial supplier, Chart Tech, Inc., Evanston, Ill. The advantage to using XML is the fact that it is self-describing, that is, you know exactly what data that is being submitted. Through implementation of XML, CCMS also has the ability to streamline the data flow, by separating data validation logic from the import routines. CCMS parses XML data streams through the use of standard XML schemas, which provide validation of semantics, data completeness, data integrity and data corruption. Unlike ASCII or NSF formats, where data could easily become corrupted through a misapplication of a tab, a comma or a line break, XML schemas give CCMS the capability to validate any data that goes into the system with increased efficiency, and notify the sender of any data corruptions before they are saved into the database. XML schemas also gave CCMS developers the freedom to concentrate more on system development rather than on writing validation code for import subroutines because XML parsers handle that functionality.

This process recognizes that sometimes systems require tighter integration than what is provided through file imports. CCMS features external Soap (XML/HTTP) interfaces that facilitate seamless loosely coupled integration modules that allow decentralized systems to communicate transparently through the web. The interfaces allow platform independent communication between systems through function calls facilitated by Soap. Using Soap messaging eliminates the need for systems to talk through integration and import of files, and rather focus on handling of business requirements, because Soap messaging simulates function calls, which bare no significant impact on platform specific implementation.

II. Calculation Services

The calculation services engine (“CSE”) is a software development kit (“SDK”) comprised of objects and interfaces which use data driven logic to calculate claims based on specific contracts. The engine is made up of several libraries (each library representing a different payer/product/plan) and each library is made up of objects, each object representing a specific hospital. The system is based on subroutine principals of object-oriented development and adheres to inheritance standards in order to increase code reuse and improve system maintainability. CCMS CSE is based on the core framework, which covers base contract calculations:

Inpatient:

Stop Loss (Outlier) logic

DRG-Based Logic

Room And Board Revenue Code Logic

Outpatient:

Stop Loss (Outlier) logic

APC Logic

Revenue Code Logic

ICD-9 Logic

CPT Logic

Any new contract that is created by the user in the system automatically possesses all the necessary functionality necessary to calculate claims. In the event that new contract logic varies from base logic, the user has the ability to overwrite any existing functionality in, the new contract object, without altering base contract calculation module. The benefits of using inheritance in CCMS CSE are as follows:

Minimize-code re-uses

Modularize systems development

Avoid complications, conflicts and confusing “spaghetti code” frequently associated with systems that use a single subroutine to process claims, through separation of business logic

Increase productivity, by providing the developers with a solid and extensible SDK that provides quick deployment, high extensibility and low cost maintenance of business rules and contracts.

Another feature incorporated in the SDK is the “process trail” functionality. The process trail (“PT”) is an innovative new concept of documenting the source code. It functions as an electronic thumbprint outlining all the factors that contribute to the calculation of a specific claim. The process trail is a process-level XML-based token, which accompanies every step of the calculation process and covers every possible permutation of calculations. As the calculation for a specific claim is processed, the process trail is built up and is then stored in the database in an XML format. One of the most powerful features of PT is the fact that the format is XML. Because PT is XML based, the output result can be presented in an unlimited number of formats through the application of extensible style sheets (“XSL”). Additionally, because of the XML-based format, the process trail can also be used later on for analysis.

III. Reporting Services

Reporting services is a generic reporting framework, which allows the end user to generate any report based on any criteria on the dataset originating from virtually any data source. Report services is a software development kit (“SDK”) that features an object model, which facilitates a simple manipulation of structured queries, which are executed against the database. Unlike traditional reporting systems, this open source SDK allows for the creation of very complex reports and at the same time requires no special client licenses to view reports, because the entire framework is based on the XML/XSL/HTML subroutine principals, and the end users only need a web browser to use the tool. The unique architecture of the framework allows retrieval of data in the following formats:

XML

HTML

Excel®

Portable Document Format (PDF)

Because the SDK is based on XML framework, the data could be sent into any other system, including portable devices, for integration or further analysis. The developers and end users-also have the ability to create sophisticated style sheets (XSL) that transform XML data into various formats “on the fly”. The SDK also features Soap interface that can be used to integrate systems or further extend reporting capabilities into other systems.

The SDK is comprised of the following components:

SQL Query Builder

Report/Criteria Manager

Web Query Interface

SQL query builder is a generic collection of objects used as a wrapper around SQL statements (i.e. the library gives the developer the ability to manipulate SQL through manipulation of objects). The collections are used to define relationships between data sets, provide field selections, and facilitate sorting and filtering of data. As a result, the object generates a standard query that can be executed against any database.

Report/criteria manager is a GUI application, which utilizes SQL query builder to generate various view, reports, and criteria that will be available for the end users. A designated system administrator is responsible for the set up and maintenance of application reports. The system administrator has the ability to specify what data will be available to the report, how it will be sorted, how it can be filtered and who has access to the report.

Web query interface is an all HTML web-based query tool, which allows the end user to view any report in the system that was deployed using the report manager. If the end user has the necessary privileges to view a specific report, the user can specify how the report should be filtered and sorted and only return the data that fits the user's criteria. This system is very powerful because it gives all parties (end users and system administrators) a great deal of control over how the data is viewed and distributed, while at the same time providing a simple and extensible interface both on the programming and on the GUI sides.

IV. Security/Security Management Services

Incorporated into this process are the key components of security and data privacy, which is why the entire system is focused around very strict security protocols. Security in CCMS is based on the following five key components:

External Firewall Security

Operating System Security

Database Security

Internet Transmission Security (HTTPS-SSL)

Application Level/Subscription Based Security (Security Management Services/SMS)

The process provides for data safety, as part of the system industry leaders in Internet and firewall security to protect the system from external breaches.

A strict operating system and database security policies are in place as part of the process in order to prevent access to or tampering with the data and or the application in the highly unlikely event that the firewall and server security has been compromised. Part of the process ensures that data must also be secured once it has left the server. Because the system is web-based, the system must ensure that the data is protected while it is in transit between users server and the client's browser. This is accomplished through the use of 128-bit SSL. SSL is a technology that encrypts (scrambles) the data when it leaves the server and can only be decrypted by the browser that is making the request. If a third party were to intercept the data, it would be impossible to break the encryption.

SMS is an access control list (ACL)-based framework designed to regulate access to various resources in the application and to provide subscription-based content to endusers. The application has the capability to manage users and user groups, provide access and level of access to various system resources such as:

System Access

Hospital Access

Report and Data Access

The system also features high-powered RC4 and one way hashing encryption algorithms for maximum in security and privacy.

V. Analysis Services

The system recognizes that one of the most important components associated with managed care is the ability to pinpoint weak areas in the managed care payment system in order to quickly resolve the problem and insure the highest level of accuracy.

This is accomplished through the following four main mechanisms:

Audit Code assignment

Audit Trail/Correspondence/Analysis Tools

Adjustment History Report

Details Billing Data Summary

Claims Adjustment History Report

Payment Adjustment History Report

Calculation History

CPT Worksheet

Process Trail

Analysis Summary Reports

Audit code functionality gives end users, analysts and developers from all involved parties the ability to analyze accounts that the system indicates are mis-paid and to classify them into various miss payments categories right from the web browser. The system keeps track of all the claim activity by recording a correspondence log, which indicates all the status changes and the information about the user who works with the claim. Using the correspondence utility in CCMS, end-users from the providers' and payers' claims can communicate with one another regarding a specific claim or a series of claims. This tool greatly improves productivity as well as saves money for all parties; because of the reduction of the call volume associated with the payers' customer support call centers. The system empowers end users with a vast array of analysis tools to quickly resolve problems and miss payments. The process trail provides a clear indication as to how an account was paid by providing a highly verbose narrative explaining all the conditions leading to the end result. Tools such as CPT Worksheet give analysts the ability to see how the account was paid on a procedural basis and gives the “bottom line” on what the desired payment should be. The user also has the ability to analyze all of the historical data associated with a specific claim. This includes, but is not limited to: adjustment history, payment history, claims adjustment history and calculation history. Finally, the users have the ability to run executive summary reports that summarize how the accounts are paid, summarized by variances or by Audit Code. These reports provide a comprehensive overview of the overall status of the system and can be exported into the following formats:

XML

HTML (web browser)

Excel®

PDF

VI. External Interface Services

One of the most important aspects of CCMS is the ability to cooperate with other systems. One of the largest key components of the core framework is the built in functionality that allows other systems to integrate seamlessly with CCMS. One of the early concerns of the development staff at CCMS was how system integration would be transparent enough and at the same time would not revolve around a complicated proprietary logic and standards. The answer was found in simple object access protocol (Soap). Soap is a lightweight web-based protocol that uses two open industry standards (extensible markup language (“XML”) over HTTP) to facilitate communication between distributed systems. CCMS implements Microsoft® Soap implementation version 2.0. This framework, combined with SSL and CCMS Security Services, enables seamless and secure integration of various systems. Using Soap, developers working for various entities such as payers, providers and third party administrators can establish a secure channel of communication without having to worry about the complex internal environments and data structures of CCMS. Additionally, by implementing Soap, CCMS enables Java®, Unix®, mainframe or wireless systems to communicate with one another, without having to worry about system specific implementation. Currently CCMS allows external systems to integrate with the following components:

Execute Processing Events

Submit New Data

Retrieve Data

Run Reports

Monitor System Status

VII. Contract/Confirmation Document Management Services

The Confirmation Document is the system's interpretation of the provider-payer contract(s). It is written in clear layman's language and in a table format that makes it very easy for anyone to read and comprehend. It provides a “road map” to the logic underlying calculations and removes any ambiguity; so all parties (provider, payer, analysts, developers, etc.) reviewing findings know how to interpret every element of each contract.

The Confirmation Document plays a critical role in the CCMS process in that it forms the basis for the calculation services engine (“CSE”). The provides for the fact that developers do not write a single line of code until this document is reviewed and the client has “signed-off” on each page. This ensures that the parties agree to every element of each contract before any work begins. Clients find that the document is the preferred format for contract management as it greatly simplifies these complex agreements.

CCMS Import Data Flow is a redundant data flow system that allows independent data components (billing files, claim payment files and subsequent adjustment files) to contribute to the process as a whole.

The CCMS process consists of the following key components and services:

Re-Pricer

Re-Pricing is a service that allows organizations to forecast expected revenues, discounts and payments (depending on the perspective) based on actual claims and contracts by which submitted claims are adjudicated. Re-Pricer uses the Calculation Engines in conjunction with the confirmation documents (contracts) to determine with a very high degree of accuracy what the Net Expected Payment and Discount for a specific claim should be. Both the payer and the provider can use Re-Pricer to their respective benefit.

Decision Support/Modeling

Modeling is a revenue enhancing service which allows organizations to model managed care contracts in order to determine the most favorable conditions for structuring contracts on services performed. The Modeling service allows the end-users to modify contractual provisions in the system and run “what-if” calculations to determine what impact, if any, a modification in the contract has to the bottom line. Both the payer and the provider can use Modeling to their respective benefit.

Managed Care Contract Compliance Audit

The managed care contract compliance audit is a comprehensive and all encompassing review of all claims submitted to the payer by a provider. The audit calculates every claim and makes determination by examining the extent to which the expected payments and discounts vary from actual payments and discounts. Every account that is processed reflects a detailed explanation as to how the account was calculated by virtue of the “process trail”. After the claims are processed, all the mis-paid accounts are analyzed and classified into a specific mis-payment categories known as the “audit codes”. The end users then have the ability to log in to a secure web site to run custom reports to resolve and analyze all mis-paid accounts.

In order to understand different import processes, the user needs to examine how an insurance company adjudicates claims.

The provider submits claims data to the payer.

The payer processes the claim and returns to the provider a remittance advice or payment summary voucher for specific claims.

The payer adjusts the payment for a specific claim by taking a discount or “contractual allowance”. The discount is the difference between the full charges submitted by the provider and the payment made by the payer.

The CCMS framework is designed for maximum flexibility and extensibility. It also facilitates the import of data from various sources through the use of XML. The calculation engine is flexible enough that with billing data alone (in the absence of claim payment data), it can function as a pre-pricer. With the addition of claim payment data, the engine can compare net expected payment to the actual payment and determine payment and discount variances (the audit).

Billing data import service facilitates the accumulation of basic claims data, which is used both for adjudication of claims and the audit as well. The billing data reflects procedures that were performed for a patient. Based on that data, the payer can make a determination as to how much should be paid based on a specific contract. CCMS uses the billing data the same way the payer does; that is, CCMS utilizes billing data to determine what the expected payment and discount should be according to contractual provisions. Preliminary indications are that CCMS performs at higher degree of accuracy than the payer systems. Once the billing data is imported into the system, CCMS can use that information to provide the Pre-Pricing and Decision Support services.

Claim payment data and adjustment data service does not facilitate in the calculation of what the net expected payment should be, but it does assist in the audit portion of the service. Once claim payment and claim adjustment data becomes available, the system can perform reliable comparisons and assess the degree to which the mis-payment occurred in any of the following ways:

Expected payment variances→The system compares the net expected payment to what was actually paid by the payer to the provider.

Discount variances→Once the system calculates the net expected payment, it can calculate expected discount (expected allowance) and compare that to the actual allowance taken by the payer.

Claims data variances→Once all the information is collected, the system can easily identify all claims where there are discrepancies between the amounts billed by the provider and amounts recognized by the payer. Those claims can be summarized in reports, as they require review for further adjudication via the proper claims processes.

After the necessary data is imported, the calculation engine processes the claims. The calculation engine activates contract specific processing agents. Supporting data and contractual provisions are loaded into these agents and the agents process the accounts (on an element by element basis, there being potentially many elements contributing to the net expected payment for a single claim). Additionally, the agents assess the data for any “exceptions” that may apply. The exceptions are numeric codes that indicate the account contains unique characteristics that are germane to the calculation of net expected payment. (Examples of exceptions include: a) the payer is both the primary and secondary payer on this claim; b) this claim reflects a bio-medical device that may require additional payment; c) this is an outpatient surgical account with Observation.) Finally, the agent generates the calculation specific process trail and persists (saves) the information to the database.

After all the data is processed, it is automatically available to external data sources for extraction and/or further analysis. CCMS has a standard web portal interface, which allows users to run reports, extract data, and analyze claims. In addition to having a standard web portal, CCMS features external Soap port listeners that allow third parties to securely extract data from the system for further analysis as well as submitting data into the system for processing.

Applications include:

1) The process trail . . . reflecting exactly how the account was calculated per the contractual provisions.

2) The exception codes . . . indicating that unique characteristics are present in a particular claim.

3) The audit codes . . . (manually and/or electronically assigned), these codes allow for easy analysis of “like causes” of payment/discount error.

4) The contract summary providing claim specification qualification and quantification of the contractual terms governing the claim payment amount for that particular claim.

5) The aggregation of all billing data, claims payment data, pre-pricing and audit data in a single, easily accessible, rapid response application.

What is claimed:

1. A contract compliance monitoring system comprising:
a.) import services;
b.) calculation services;
c.) reporting/report management services;
d.) analysis services;
e.) data manipulation services;
f.) external interface services;
g.) contract/confirmation document management services;
h.) security processing and confirmation;
for comprehensive review of insurance claims and calculation of baselines for insurance claim reimbursement using a web-based simple object access protocol and related subroutines for said services and security processing and confirmation and an external data processor.

2. A contract compliance monitoring system comprising:
a.) import services;
b.) calculation services;
c.) reporting/report management services;
d.) analysis services;
e.) data manipulation services;
f.) external interface services;
g.) contract confirmation document management services;
h.) security processing and confirmation;
for comprehensive review of medical insurance claims and calculation of baselines for medical insurance claim reimbursement using a web-based simple object access protocol and related subroutines for said services and security processing and confirmation and an external data processor.

3. A method of providing a contract compliance electronic monitoring system for compliance of contract terms for insurance claim baseline reimbursement for users comprising the steps of:
a.) requesting the user's contract information;
b.) requesting and reviewing the parameters including the required data, calculations, interface, security level, confirmation, and analysis of the compliance and contract terms; and
c.) generating the reports requested by the user wherein said method uses an external data processor and a web-based simple object access protocol and related sub-routines for said steps of requesting the user's contract information, requesting and reviewing the said parameters, and generating said reports.
